(19) United States
(12) Patent Application Publication
(10) Pub. No.: US 2014/0363001 A1
(43) Pub. Date: Dec. 11, 2014

(54) METHOD FOR CALIBRATING PERFORMANCE OF SMALL ARRAY MICROPHONES

(71) Applicant: Fortemedia, Inc., Sunnyvale, CA (US)

(72) Inventors: Yen-Son Paul HUANG, Los Altos Hills, CA (US); Iou-Din Jean CHEN, San Jose, CA (US); Xi-Lin LI, Sunnyvale, CA (US); Bo-Ren BAI, Yi-Zhu-Xiang (TW)

(21) Appl. No.: 13/911,785

(22) Filed: Jun. 6, 2013

(51) Int. Cl. H04R 29/00

(52) U.S. Cl. CPC H04R 29/005
USPC 381/58

(57) ABSTRACT

A method for calibrating performance of a small array microphone is provided. The small array microphone includes at least two microphones. The method includes: measuring parameters of the microphones; recording the parameters in a storage media; and calibrating acoustic performance of the array microphone according to the parameters recorded in the storage media.

### BACKGROUND OF THE INVENTION

1. Field of the Invention

The present invention relates to array microphone calibration technology, and in particular, relates to small array microphone calibration technology.

2. Description of the Related Art

A microphone, which is a transducer that converts sound into an electrical signal, can be used for various applications such as voice communication or voice recognition.

An array microphone can have any number of microphones. The array microphone captures more sound information and can achieve better performance than a single microphone. However, mismatching among the microphones in the array microphone occur, such as the phase mismatch, sensitivity mismatch and the frequency response mismatch.

Small array microphones (SAM) are a new type of array microphones, which require there be only 5 mm between any two microphones. Therefore, the small array microphone can be used in any environment with greater application. Compared with the traditional wide array microphones (any two microphones therein has to be apart from each other by at least 30 mm), the parameter mismatch problems in the small array microphones are more serious and therefore require a completely different algorithm to process sounds and voices.

### BRIEF SUMMARY OF THE INVENTION

The present invention provides a method for calibrating performance of a small array microphone (SAM), wherein the small array microphone comprises at least two microphones. The method comprises: measuring parameters of the microphones; recording the parameters in a storage media; and calibrating acoustic performance of the array microphone according to the parameters recorded in the storage media.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a flow chart of a method for calibrating performance of a small array microphone (SAM) according to an embodiment of the present invention;

FIG. 2 is a detailed flow chart of the measuring procedure;

FIGS. 3A and 3B both show the sound insulation cabin 302, the loudspeaker 304 and the array microphone of the present invention; and

FIG. 4 shows two microphones 402 and 404 of a small array microphone.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

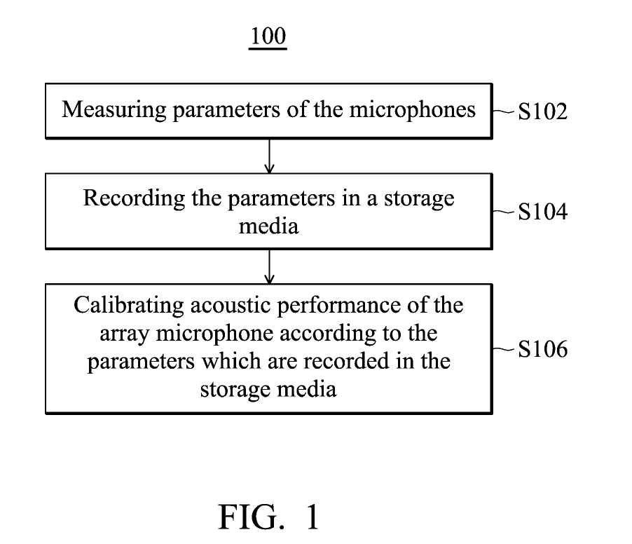

FIG. 1 shows a flow chart of a method for calibrating performance of a small array microphone (SAM) according to an embodiment of the present invention. Similar to the traditional array microphone, the small array microphone comprises at least two microphones (a microphone pair). However, different from the traditional array microphone, the small array microphone has a much shorter distance between any two microphones thereof. The method 100 comprises: in step S102, measuring parameters of the microphones; in step S104, recording the parameters in a storage media; and in step S106, calibrating acoustic performance of the array microphone according to the parameters which are recorded in the storage media. In the present invention, the parameters hereinafter comprise at least one of the phase, the sensitivity and the frequency response of the microphones. These steps will be further described in detail in the following paragraphs.

### Measuring Procedure

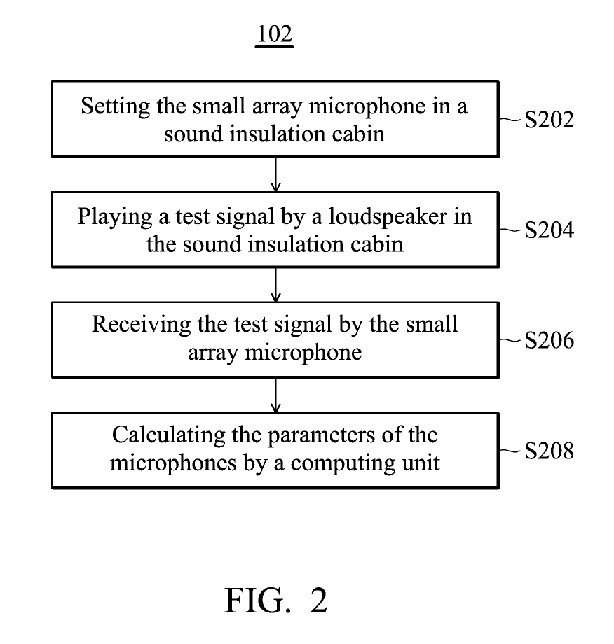

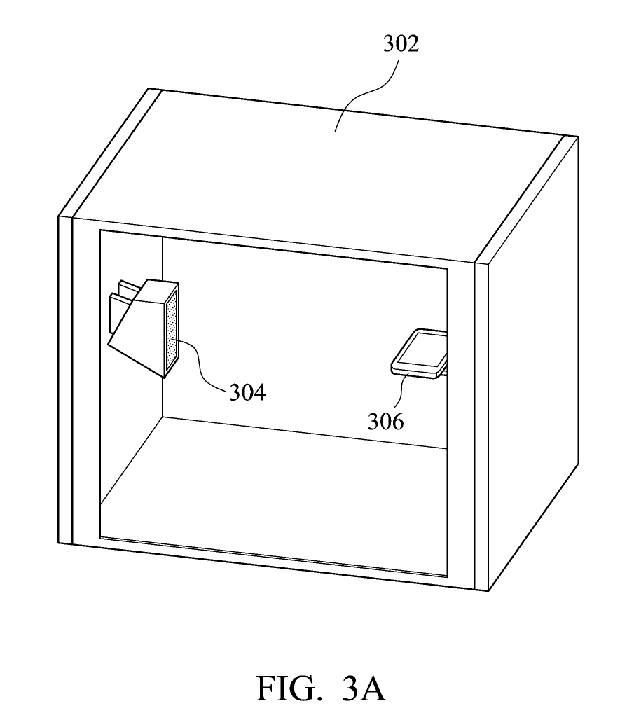

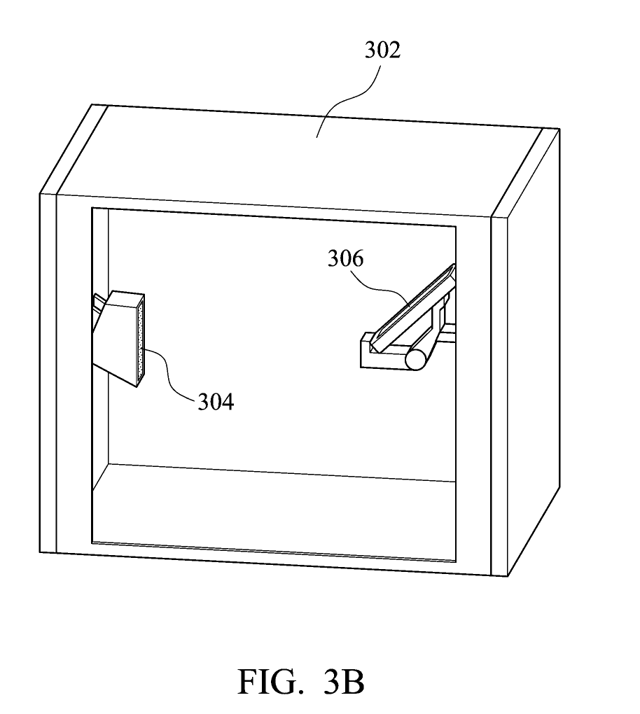

FIG. 2 is a detailed flow chart of the measuring procedure (step S102 of FIG. 1). The measuring procedure of the present invention comprises: in step S202, setting the small array microphone in a sound insulation cabin; in step S204, playing a test signal by a loudspeaker in the sound insulation cabin; in step S206, receiving the test signal by the small array microphone; and in step S208, calculating the parameters of the microphones by a computing unit. FIGS. 3A and 3B both show the sound insulation cabin 302, the loudspeaker 304 and the array microphone of the present invention, where the array microphone is configured in a mobile phone 306 which is respectively arranged in a different way in FIGS. 3A and 3B. Note that the way of arranging the array microphone may cause variations in the parameters thereof. However, the more the parameters are measured, the better the acoustic performance of the array microphone after the calibration procedure.

The way for arranging the array microphone in the sound insulation cabin should not be limited to the embodiments in FIGS. 3A and 3B. In an embodiment, the test signal played by the loudspeaker is a white noise. In another embodiment, the test signal played by the loudspeaker is a sweep tone. In an embodiment, the computing unit (not shown in FIGS. 3A or 3b) is integrated with the array microphone in the sound insulation cabin 302. In another embodiment, the computing unit is disposed in a computer (not shown in FIGS. 3A or 3b) out of the sound insulation cabin 302, but is connected to the array microphone via wire or wirelessly.

### Recording Procedure

In the recording procedure (step S104), the parameters such as the phase, the sensitivity and the frequency response of the microphones measured in the measuring procedure described above are then recorded in a storage media. In an embodiment, the storage media of the present invention is a non-volatile memory such as an EEPROM, flash memory, or hard disk. The storage media may be multiple time access-able devices such as flash memories, EEPROM memories or multiple programmable memories, or one-time programmable devices such as one-time programmable (OTP) memories, Efuse cells and Laser trim structures. The storage media of the present invention can be integrated with the array microphone, or configured in a device such as a computer that is separate from but connected to the array microphone.

### Calibrating Procedure

In the calibration procedure (step S106), the acoustic performance of the array microphone can be calibrated according to the parameters of the microphones (e.g., the phase, the sensitivity and the frequency response) which are recorded in the recording procedure. The present invention provides embodiments for calibrating the phase mismatch (delay) as described below:

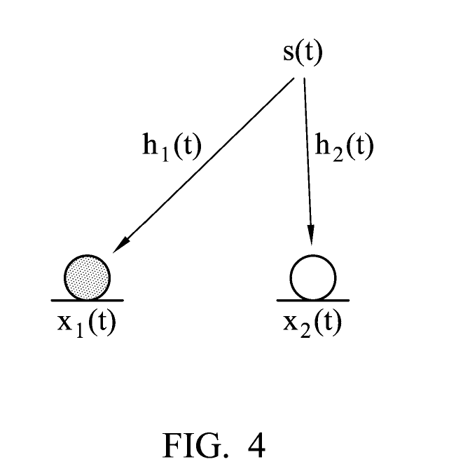

FIG. 4 shows two microphones 402 and 404 of a small array microphone. In the measuring procedure, the loudspeaker in the sound insulation cabin can play a test signal s(t) and the test signal is then received by the two microphones 402 and 404. The equation of the received test signal are as follows:

x1(t)=h1(t)*s(t); and

x2(t)=h2(t)*s(t),

where the symbol “*” denotes the convolution operation, the symbols h1(t) and h2(t) respectively denote the impulse responses from the source to the two microphones 402 and 404. The received test signals x1(t) and x2(t) can be combined into the following equation:

x1(t−t0)=x2(t) (equation 1),

where t1 is a delay which compensate for the difference between the propagation paths from the source to the two microphones. Then the following equation for the two filters w1(t) and w2(t) may be designed to eliminate the delay:

w1(t)*x1(t−t0)=w2(t)*x2(t) (equation 2).

To simplify the calculation, equation 2 may be translated to the Z domain as follows:

W1(z) W2(z)=z−D (equation 3),

where the symbol “D” represents the delay in the Z domain, having a nonnegative value. In some embodiments, the following equation may apply to the filters:

minimize E [w1(t)*x1(t−t0)−w2(t)*x2(t)]² (equation 4).

Note that the calibration procedure described above can be implemented for an array microphone that has two or more than two microphones, which receives sounds from several sources with different incident angles. The calibration procedure can also be performed in the time domain, the frequency domain, or others.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for calibrating performance of a small array microphone (SAM), wherein the small array microphone comprises at least two microphones; the method comprising
measuring parameters of the microphones;
recording the parameters in a storage media; and
calibrating acoustic performance of the array microphone according to the parameters recorded in the storage media.

2. The method as claimed in claim 1, wherein the storage media is integrated with the array microphone.

3. The method as claimed in claim 1, wherein the storage media is configured in a device that is separate from but connected to the array microphone

4. The method as claimed in claim 1, wherein the step of measuring parameters of the array microphone further comprises:
setting the small array microphone in a sound insulation cabin;
playing a test signal by a loudspeaker in the sound insulation cabin;
receiving the test signal by the small array microphone; and
calculating the parameters of the microphones by a computing unit.

5. The method as claimed in claim 4, wherein the test signal is a white noise.

6. The method as claimed in claim 4, wherein the test signal is a sweep tone.

7. The method as claimed in claim 1, wherein the parameters comprise phases of the microphones.

8. The method as claimed in claim 1, wherein the parameters comprise sensitivities of the microphones.

9. The method as claimed in claim 1, wherein the parameters comprise frequency responses of the microphones.
